(19) United States
(12) Patent Application Publication
(10) Pub. No.: US 2008/0294737 A1
(43) Pub. Date: Nov. 27, 2008

(54) METHOD OF SENDING EMAIL FROM IMAGE FORMING APPARATUS, AND IMAGE FORMING APPARATUS CAPABLE OF SENDING EMAIL

(75) Inventor: Han-nam KIM, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/124,222

(22) Filed: May 21, 2008

(30) Foreign Application Priority Data
May 21, 2007 (KR) 2007-49310

(51) Int. Cl. G06F 15/16

(52) U.S. Cl. 709/206

(57) ABSTRACT

A method of sending email in an image forming apparatus, and an image forming apparatus capable of sending email, the method including: receiving a user selection of a file that is to be transmitted via email, from among one or more files stored outside of the image forming apparatus; generating an email including the selected file; and sending the email. Accordingly, the range of files that can be transmitted in the image forming apparatus increases, thereby improving the efficiency and convenience of email transmission.

### CROSS-REFERENCE TO RELATED APPLICATION

This application claims the benefit of Korean Application No. 2007-49310, filed May 21, 2007, in the Korean Intellectual Property Office, the disclosure of which is incorporated herein by reference.

### BACKGROUND OF THE INVENTION

1. Field of the Invention

Aspects of the present invention relate to an image forming apparatus, and more particularly, to a method of sending email from an image forming apparatus, and an image forming apparatus capable of sending email.

2. Description of the Related Art

Image forming apparatuses (such as copiers, facsimiles, printers, and multi-function peripherals) generate data by scanning a document and/or form an image by printing data onto a print medium (such as paper, transparencies, etc.). Recently, image forming apparatuses supporting a networking operation have become widely available. In particular, image forming apparatuses that support a scan-to-email function of transmitting data, obtained by scanning a document, directly via electronic mail (email) without using a personal computer (PC) have become widely available and extensively used.

In the case of a conventional image forming apparatus supporting the scan-to-email function, a user places documents that are to be transmitted on an Automatic Document Feeder (ADF) or on a flatbed of the image forming apparatus in order to scan the documents and then sends an email transmission command. Accordingly, the image forming apparatus generates image files by scanning the documents, and transmits, via email, the image files to a previously input email address.

Such a conventional image forming apparatus is inconvenient to use since the image forming apparatus can transmit via email only a scanned image file but cannot transmit via email a previously stored file. Furthermore, an image file generated by scanning a document and a file stored outside of the image forming apparatus must be individually transmitted via email from different locations so as to transmit them to the same destination.

### SUMMARY OF THE INVENTION

Aspects of the present invention provide a method of sending email in an image forming apparatus by increasing the range of files that the image forming apparatus can transmit, an image forming apparatus capable of sending email by increasing the range of files that the image forming apparatus can transmit, and a computer readable medium having recorded thereon a program for executing the above method, thereby improving the efficiency and convenience of email transmission.

According to an aspect of the present invention, there is provided a method of sending email from an image forming apparatus, the method including: receiving a user selection of a file that is to be transmitted via email, from among one or more files stored outside of the image forming apparatus; generating an email including the selected file; and sending the email.

The method may further include generating an image file by scanning a document, wherein the generating of the email includes generating the email to include the selected file and the generated image file.

The generating of the email may include generating the email by attaching the selected file to the email.

The stored files may be stored in an external device connected to the image forming apparatus via a network, or in a storage medium included in the image forming apparatus.

The files stored inside of the image forming apparatus may be image files obtained by scanning a document, using the image forming apparatus.

The method may further include receiving a user selection as to whether to transmit an image file generated by scanning a document or to transmit the stored files.

The method may further include receiving a user selection as to whether to transmit either the files stored inside of the image forming apparatus, or the files stored outside of the image forming apparatus; and if the files stored inside of the image forming apparatus are selected for transmission, displaying a list of the files stored inside of the image forming apparatus.

The method may further include receiving a user selection as to whether to transmit the files stored inside of the image forming apparatus, or the files stored outside of the image forming apparatus; and if the files stored outside of the image forming apparatus are selected for transmission, displaying a list of external devices storing the files outside of the image forming apparatus.

The method may further include receiving a user selection of at least one device from the displayed list of external devices; and displaying a list of files stored in the selected device.

According to another aspect of the present invention, there is provided an image forming apparatus capable of sending email, the apparatus comprising a user interface unit to receive a user selection of a file that is to be transmitted via email, from among one or more files stored outside of the image forming apparatus; an email generation unit to generate an email including the selected file; and a transmission unit to transmit the generated email.

The apparatus may further include an image generation unit to generate an image file by scanning a document, wherein the email generation unit generates the email to include the selected file and the generated image file.

The email generation unit may generate the email by attaching the selected file to the email.

The stored files may be stored in external devices connected to the image forming apparatus via a network, or in a storage medium included in the image forming apparatus.

The apparatus may further include a storage medium, wherein the files stored inside of the image forming apparatus are stored in the storage medium.

The user interface unit may receive a user selection as to whether to transmit at least one of the files stored inside of the image forming apparatus or at least one of the files stored outside of the image forming apparatus, and may display a list of the files stored inside of the image forming apparatus if at least one of the files stored inside of the image forming apparatus is selected for transmission.

The user interface unit may receive a user selection as to whether to transmit at least one of the files stored inside of the image forming apparatus or at least one of the files stored outside of the image forming apparatus, and may display a list of devices storing the files stored outside of the image forming apparatus if at least one of the files stored outside of the image forming apparatus is selected for transmission.

Also, the user interface unit may receive a user selection of at least one device from the displayed list of devices, and may display a list of files stored in the selected device.

According to another aspect of the present invention, there is provided a computer readable medium having recorded thereon a program for executing a method of transmitting email from the above image forming apparatus.

According to yet another aspect of the present invention, there is provided a method of sending email from an image forming apparatus, the method including: receiving a user selection of an option, from a plurality of options, of a file source; receiving a user selection of a file that is to be transmitted via email, from among one or more files stored in the file source corresponding to the selected option; generating an email including the selected file; and sending the email, wherein the plurality of options comprises a first option corresponding to a storage medium inside of the image forming apparatus, and a second option corresponding to a storage medium outside of the image forming apparatus.

According to still another aspect of the present invention, there is provided a method of sending email from an image forming apparatus, the method including: receiving a user selection of an option, from a plurality of options, of a file source; receiving a user selection of a file that is to be transmitted via email, from among one or more files stored in the file source corresponding to the selected option; generating an email including the selected file; and sending the email, wherein the plurality of options comprises a first option corresponding to a storage medium outside of the image forming apparatus, and a second option corresponding to an image file to be generated by scanning a document.

According to another aspect of the present invention, there is provided an image forming apparatus capable of sending email, the apparatus including: a user interface unit to receive a user selection of an option, from a plurality of options, of a file source, and to receive a user selection of a file that is to be transmitted via email, from among one or more files stored in the file source corresponding to the selected option; an email generation unit to generate an email including the selected file; and a transmission unit to transmit the generated email, wherein the plurality of options comprises a first option corresponding to a storage medium inside of the image forming apparatus, and a second option corresponding to a storage medium outside of the image forming apparatus or an image file to be generated by scanning a document.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an image forming apparatus according to an embodiment of the present invention;

FIGS. 2A and 2B are a flowchart illustrating a method of sending email in an image forming apparatus according to an embodiment of the present invention;

FIG. 3 is a flowchart illustrating in detail operation 290 illustrated in FIG. 2 according to an embodiment of the present invention; and

FIG. 4 illustrates an email sent from an image forming apparatus, the email having both an image file generated by scanning and a previously stored file attached thereto, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

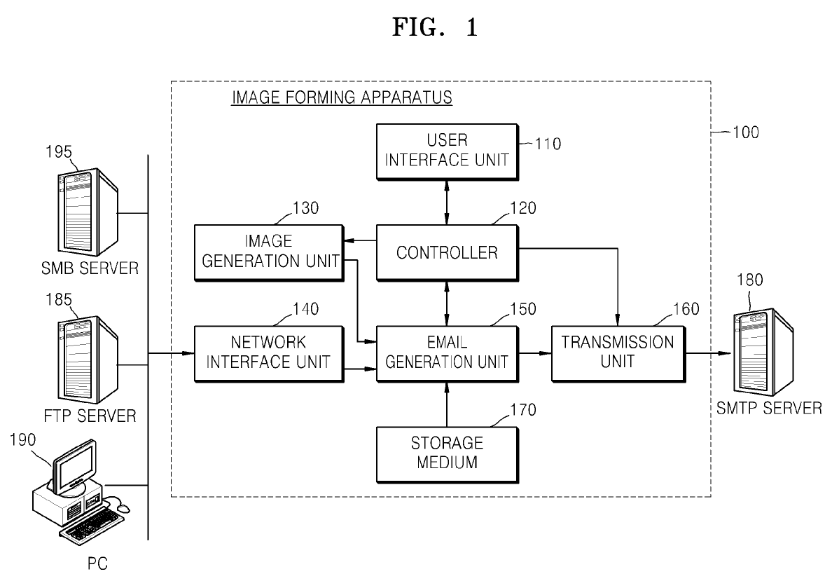

FIG. 1 is a block diagram of an image forming apparatus 100 according to an embodiment of the present invention. The image forming apparatus 100 includes a user interface unit 110, a controller 120, an image generation unit 130, a network interface unit 140, an email generation unit 150, a transmission unit 160, and a storage medium 170. Furthermore, the image forming apparatus 100 is connected, via a network, to a server message block (SMB) server 195, a file transfer protocol (FTP) server 185, a personal computer (PC) 190, a simple mail transfer protocol (SMTP) server 195, etc. However, it is understood that aspects of the present invention are not limited thereto. In particular, the image forming apparatus 100 need not be connected to all of the aforementioned devices 180, 185, 190, and 195, may only be connected to one of the devices 180, 185, 190, or 195, or may be connected additionally or alternatively to a different type of file receiving and/or storing device.

The user interface unit 110 receives a user command to control the operation of the image forming apparatus 100, and transmits the user command to the controller 120 (which will be described in detail later). The user interface unit 110 may also display, for a user's recognition, a variety of information upon which can be based a command that a user desires to input, and information indicating a state of the image forming apparatus 100.

The controller 120 controls the components of the image forming apparatus 100 (such as the user interface unit 110, the image generation unit 130, the email generation unit 150, and the transmission unit 160), according to the user command received from the user interface unit 110.

The image generation unit 130 generates one or more image files by scanning a document. In particular, the image generation unit 130 scans a document that a user desires to transmit via email. For example, document scanning may be automatically performed using an Automatic Document Feeder (ADF) (not shown). In this case, the image generation unit 110 scans a document provided via the ADF in order to generate an image file for each page of the document. It is understood that the document may be scanned by other methods, such as a flatbed scanning method. The image files that the image generation unit 110 generates may be generated in an image format such as Tag Image File Format (TIFF), Joint Photographic Experts Group (JPEG), Graphic Interchange Format (GIF), Bitmap Format (BMP), and Portable Document Format (PDF).

The network interface unit 140 establishes a communication with one or more external devices (e.g., the SMB server 195, the FTP server 185, and/or the PC 190) via a network, as illustrated in FIG. 1. Files that a user is to transmit via email may be stored in the SMB server 195, the FTP server 185, and/or the PC 190. The email generation unit 150 can read the files from the SMB server 195, the FTP sever 185, and/or the PC 190 via the network interface unit 140.

The storage medium 170 may store the image files generated by the image generation unit 130 or the files read via the network interface unit 140. However, it is understood that not all the generated image files and the read files are stored, but may instead be selectively stored according to a user's selection input via the user interface unit 110. The storage medium 170 may be a mass storage device and may support a file management function.

The email generation unit 150 generates an email by selectively attaching the generated image files, the read files, the files stored in the storage medium 170, or a combination thereof, to the email, according to a user command received via the user interface unit 110.

The transmission unit 160 transmits the email generated by the email generation unit 150 to the SMTP server 180, so that the SMTP server 180 transmits the email to an email address that the user inputs. In the current embodiment, the network interface unit 140 and the transmission unit 160 are embodied as separate constitutional elements. However, it would be apparent to those of ordinary skill in the art that aspects of the present invention are not limited thereto, and the network interface unit 140 may also perform the operations of the transmission unit 160 (i.e., establishing a communication with external devices and sending email may be performed by the same constitutional element).

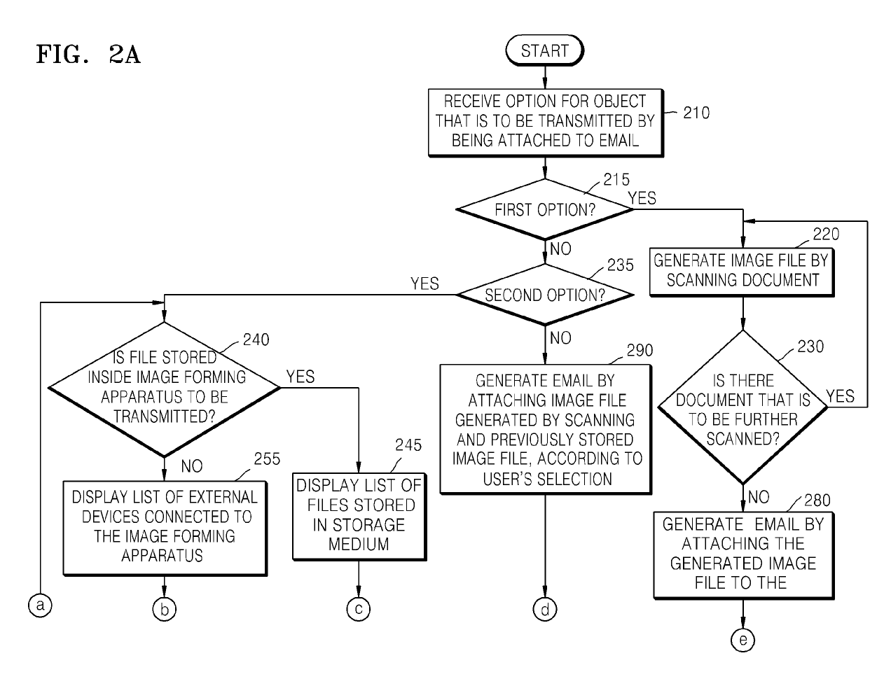

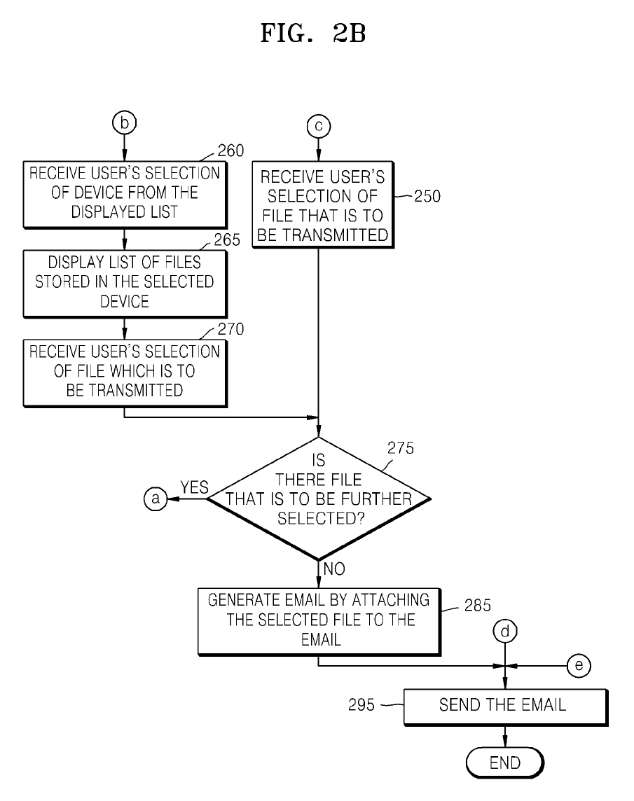

The operations of the image forming apparatus 100 according to an embodiment of the present invention will now be described in greater detail with reference to FIGS. 1, 2A, and 2B. FIGS. 2A and 2B are a flowchart illustrating a method of sending email in an image forming apparatus according to an embodiment of the present invention.

Referring to FIGS. 1, 2A, and 2B, the user interface unit 110 receives, from a user, an option for an object that is to be attached and transmitted via email. For example, the option is categorized as a first option of sending email by attaching only an image file generated by scanning a document to the email, a second option of sending email by attaching only a previously stored file to the email, and a third option of selectively attaching the image file and the previously stored file to the email. In the current embodiment, the image forming apparatus 100 is described as operating according to the above three options. However, it is understood that aspects of the present invention are not limited thereto, and option for an object that is to be attached and transmitted via email may be categorized in various other ways. For example, the second option may be subdivided into an option of transmitting a file that is previously stored in the image forming apparatus 100 and an option of transmitting a file that is previously stored outside the image forming apparatus 100. That is, at least four options may be embodied.

Next, if it is determined in operation 215 that the first option is selected in operation 210, the image generation unit 130 generates an image file by scanning a document in operation 220. If it is determined in operation 230 that there is still another document that is to be scanned, the method returns to operation 220. Conversely, if it is determined in operation 230 that there is no other document that is to be scanned, the email generation unit 150 generates an email by attaching the generated image file or files (operation 220) to the email in operation 280.

If it is determined in operation 215 that the first option is not selected in operation 210, the method proceeds to operation 235. If it is determined in operation 235 that the second option is selected in operation 210, the user interface unit 110 receives, from the user, a selection as to whether to transmit a file stored inside the image forming apparatus 100 or a file stored outside the image forming apparatus 100 in operation 240. If the file stored inside the image forming apparatus 100 is selected for transmission in operation 240, the user interface unit 110 displays a list of files stored in the storage medium 170 in operation 245. Then, the user interface unit 110 receives the user's selection of a file to be transmitted via email from among the displayed list of files in operation 250. If it is determined in operation 275 that another file is to be selected from the list, the method returns to operation 240 in order for the other file can be selected. If it is determined in operation 275 that there is no other file to be further selected from the list, the email generation unit 150 generates an email by attaching the file or files to the email in operation 285.

If the file stored outside the image forming apparatus 100 is selected for transmission in operation 240, the user interface unit 110 displays a list of external devices (such as the SMB server 195, the FTP server 185, and the PC 190) that are connected to the image forming apparatus 100 in operation 255. Next, in operation 260, the user interface unit 110 receives the user's selection of a device from among the displayed list of external devices, and, in operation 265, the user interface unit 110 displays a list of files stored in the selected device (operation 260). Then, the user interface unit 110 receives the user's selection of a file that is to be transmitted via email from among the displayed list of files in operation 270. If it is determined in operation 275 that another file is to be selected, the method returns to operation 240 so that the other file can be selected. If it is determined in operation 275 that there is no other file to be further selected, the email generation unit 150 generates an email by attaching the file or files to the email in operation 285.

In operation 285, the email generation unit 150 reads the file or files selected from among the files stored in the external devices (operation 270) or the storage medium 170 (operation 250), and generates an email by attaching the read file or files to the email.

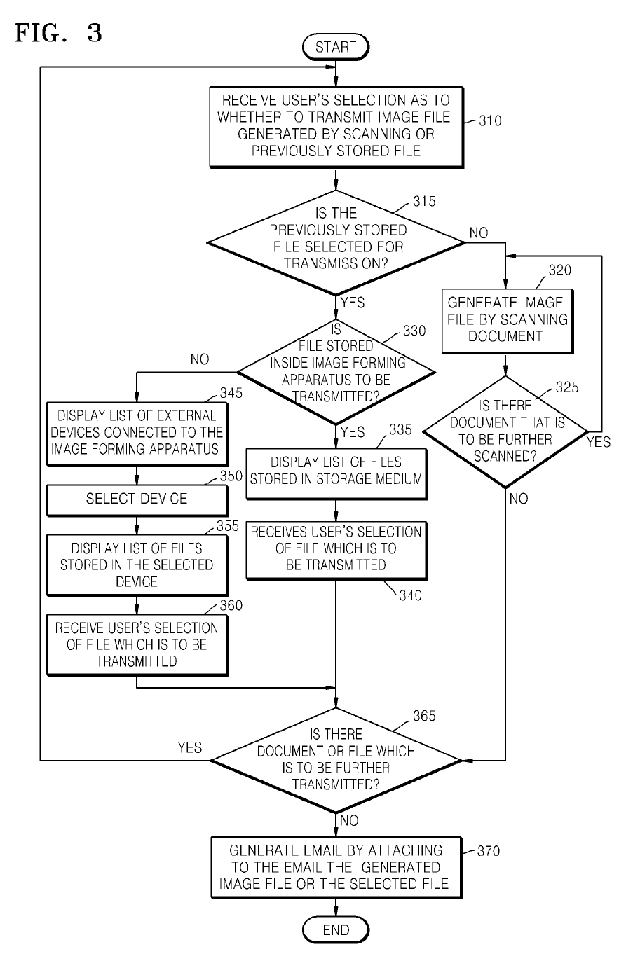

Returning back to operation 235, if it is determined that the second option is not selected (e.g., the third option is selected), the image forming apparatus 100 generates an email by attaching the generated image file and the previously stored image file to the email according to the user's selection in operation 290. Operation 290 will be described in greater detail with reference to FIG. 3.

Lastly, in operation 295, the transmission unit 160 transmits the email generated in operation 280, 285, or 290 to the SMTP server 195.

FIG. 3 is a flowchart illustrating, in detail, operation 290 of FIG. 2 according to an embodiment of the present invention. Referring to FIG. 3, the user interface unit 110 receives the user's selection as to whether to transmit an image file generated by scanning a document or a previously stored file in operation 310.

If it is determined in operation 315 that the generated image file is selected for transmission, the image generation unit 130 generates an image file by scanning a document. If it is determined in operation 325 that there is another document to be scanned, the method returns to operation 320. If it is determined in operation 325 that there is no other document to be scanned, the method proceeds to operation 365.

If it is determined in operation 315 that the previously stored file is selected for transmission, the user interface unit 110 receives the user's selection as to whether to transmit a file stored inside the image forming apparatus 100 or a file stored outside the image forming apparatus 100 in operation 330. If a file stored inside the image forming apparatus 100 is selected for transmission, the user interface unit 110 displays a list of files stored in the storage medium 170 in operation 335. Then, the user interface unit 110 receives the user's selection of a file that is to be transmitted via email from among the displayed list of files in operation 340.

If a file stored outside the image forming apparatus 100 is selected for transmission in operation 330, the user interface unit 110 displays a list of external devices (such as the SMB server 195, the FTP server 185, a Hypertext Transfer Protocol (HTTP) server (not shown), and a Lightweight Directory Access Protocol (LDAP) server (not shown) that are connected to the image forming apparatus 100 in operation 345. Then, the user interface unit 110 receives the user's selection of a device storing a file that is to be transmitted from among the displayed list of external devices in operation 350, and displays a list of files stored in the selected device in operation 355. In operation 360, the user interface unit 110 receives the user's selection of a file that is to be transmitted via email from among the displayed list of files.

If it is determined in operation 365 that there is an image file of a document or a previously stored file that is to be additionally transmitted via email, the method returns to operation 310 so that the document can be scanned or the previously stored file can be selected. If it is determined in operation 365 that there is no image file of a document or a previously stored file that is to be additionally transmitted via email, the email generation unit 150 generates an email by attaching the image file or image files generated in operation 320 and/or the file or files selected in operation 340 and/or 360 to the email. For example, if both operations 320 and 340 are performed, the email generation unit 150 generates the email by attaching both the generated image file and the file stored in the storage medium 170 of the image forming apparatus 100 together to the email. Similarly, if both operations 320 and 360 are performed, the email is generated by attaching both the generated image file and the file stored in an external device connected to the image forming apparatus 100 together to the email.

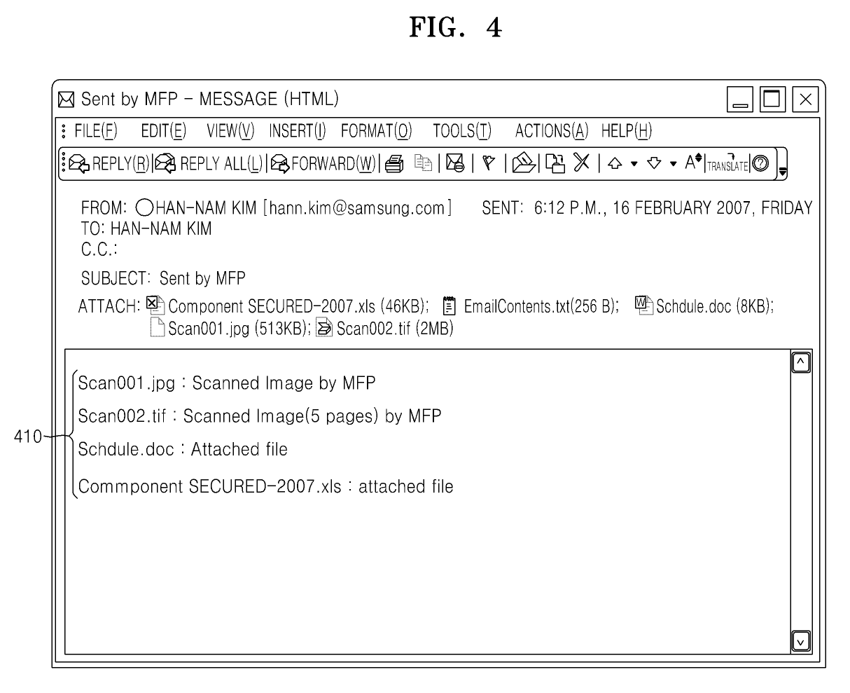

FIG. 4 illustrates an email sent from the image forming apparatus 100 of FIG. 1, the email having an image file generated by scanning and a previously stored file attached thereto, according to an embodiment of the present invention. Referring to FIG. 4, the email is attached with image files, generated by scanning, named “Scan001.jpg” and “Scan002.tif”, and files, which have been previously stored in the storage medium 170 included in the image forming apparatus 100 or stored in external devices, named “Component Secured-2007.xls,” “EmailContents.txt,” and “Schedule.doc.” The attached files are listed in an attachment field 410 of the email.

As described above, according to aspects of the present invention, a user's selection of a file that is to be transmitted via email, from among files stored in a storage medium included in an image forming apparatus or in one or more external devices connected to the image forming apparatus via a network, is received, the selected file is attached to an email, and then the email is transmitted. Thus, compared to a conventional method of transmitting only an image file generated by scanning a document, it is possible to significantly increase the range of files that can be transmitted from the image forming apparatus. Furthermore, according to aspects of the present invention, both an image file generated by scanning in an image forming apparatus and a file stored in an external device connected to the image forming apparatus via a network, can be attached together to an email that is to be transmitted. Accordingly, it is possible to overcome the inconvenience of a conventional method, whereby an image file generated by scanning a document and a file stored outside the image forming apparatus must be individually transmitted from different locations so as to transmit them to the same destination. In other words, a conventional email transmission method that must be performed several times from different locations can be replaced with an email transmission process that is performed only once from an image forming apparatus. Also, according to aspects of the present invention, it is possible to store an image file that is generated by scanning in the image forming apparatus in a storage medium included in the image forming apparatus, attach the image file to an email, and then send the email. Accordingly, there is no longer a need to perform scanning again when an already scanned document must be retransmitted via email, thereby increasing work efficiency.

The abovementioned aspects of the present invention can be embodied as a program that can be executed in a computer, and realized in a general digital computer capable of executing the program, using a computer-readable medium. The data structure used in the above embodiments can be recorded on a computer-readable medium via various devices. The computer-readable medium may be, for example, a magnetic storage medium (e.g., a read-only memory (ROM), a floppy disk, and a hard disc), or an optical recording medium (e.g., a compact disc (CD)-ROM, a digital versatile disc (DVD)).

As described above, according to aspects of the present invention, the range of files that an image forming apparatus can transmit by email includes, not only image files generated by scanning, but also files stored inside and/or outside the image forming apparatus, thereby increasing the efficiency and convenience of email transmission. Furthermore, unlike in a conventional method, an image file generated by scanning and a file stored in an external device connected to the image forming apparatus via a network can be transmitted by performing, only once, a process of attaching both files together in an email and sending the email.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of sending email from an image forming apparatus, the method comprising:
receiving a user selection of a file that is to be transmitted via email, from among one or more files having been previously prepared inside or outside the image forming apparatus;
generating an email including the selected file; and
sending the email.

2. The method as claimed in claim 1, further comprising:
generating an image file by scanning a document,
wherein the generating of the email comprises generating the email to include the selected file and the generated image file.

3. The method as claimed in claim 1, wherein the generating of the email comprises generating the email by including the selected file in the email as an attachment.

4. The method as claimed in claim 2, wherein the generating of the email further comprises generating the email by including the selected file and the generated image file in the email as attachments.

5. The method as claimed in claim 1, wherein the one or more files stored outside of the image forming apparatus are stored in one or more external devices connected to the image forming apparatus via a network.

6. The method as claimed in claim 1, wherein the one or more files previously stored inside of the image forming apparatus are one or more image files obtained by scanning a document, using the image forming apparatus.

7. The method as claimed in claim 1, further comprising:
receiving a user selection as to whether to transmit an image file generated by scanning a document or the selected file,
wherein the generating of the email comprises generating the email including the selected file if the user selection is to transmit the selected file.

8. The method as claimed in claim 1, further comprising:
receiving a user selection as to whether to transmit a file stored inside of the image forming apparatus, or a file stored outside of the image forming apparatus; and
displaying a list of the one or more files stored inside of the image forming apparatus if the user selection is to transmit the file stored inside of the image forming apparatus.

9. The method as claimed in claim 1, further comprising:
receiving a user selection as to whether to transmit a file stored inside of the image forming apparatus, or a file stored outside of the image forming apparatus; and
displaying a list of external devices storing the one or more files outside of the image forming apparatus if the user selection is to transmit the file stored outside of the image forming apparatus.

10. The method as claimed in claim 9, further comprising:
receiving a user selection of at least one device from the displayed list of external devices; and
displaying a list of files stored in the selected device, from which the selected file is selected.

11. The method as claimed in claim 1, further comprising:
displaying a list of external devices storing the one or more files outside of the image forming apparatus;
receiving a user selection of at least one device from the displayed list of external devices; and
displaying a list of files stored in the at least one selected device, from which the selected file is selected.

12. A computer-readable medium having recorded thereon a program for executing the method of claim 1 and implemented by a computer.

13. An image forming apparatus capable of sending email, the apparatus comprising:
a user interface unit to receive a user selection of a file that is to be transmitted via email, from among one or more files having been previously prepared inside or outside the image forming apparatus;
an email generation unit to generate an email including the selected file; and
a transmission unit to transmit the generated email.

14. The apparatus as claimed in claim 13, further comprising an image generation unit to generate an image file by scanning a document,
wherein the email generation unit generates the email to include the selected file and the generated image file together.

15. The apparatus as claimed in claim 13, wherein the email generation unit generates the email by including the selected file in the email as an attachment.

16. The apparatus as claimed in claim 14, wherein the email generation unit generates the email by including the selected file and the generated image file in the email as attachments.

17. The apparatus as claimed in claim 13, wherein the one or more files stored outside of the image forming apparatus are stored in one or more external devices connected to the image forming apparatus via a network.

18. The apparatus as claimed in claim 13, further comprising a storage medium to store the files previously stored inside of the image forming apparatus.

19. The apparatus as claimed in claim 13, wherein the user interface unit receives a user selection as to whether to transmit a file stored inside of the image forming apparatus, or a file stored outside of the image forming apparatus, and displays a list of the one or more files stored inside of the image forming apparatus if the user selection is to transmit the file stored inside of the image forming apparatus.

20. The apparatus as claimed in claim 13, wherein the user interface unit receives a user selection as to whether to transmit a file stored inside of the image forming apparatus, or a file stored outside of the image forming apparatus, and displays a list of external devices storing the one or more files stored outside of the image forming apparatus if at least one of the files prepared outside the image forming apparatus is selected for transmission if the user selection is to transmit the file stored outside of the image forming apparatus.

21. The apparatus as claimed in claim 20, wherein the user interface unit receives a user selection of at least one device from the displayed list of external devices, and displays a list of files stored in the selected device, from which the selected file is selected.

22. The apparatus as claimed in claim 13, wherein the user interface unit displays a list of external devices storing the one or more files outside of the image forming apparatus, receives a user selection of at least one device from the displayed list of external devices, and displays a list of files stored in the at least one selected device, from which the selected file is selected.

23. A method of sending email from an image forming apparatus, the method comprising:
receiving a user selection of an option, from a plurality of options, of a file source;
receiving a user selection of a file that is to be transmitted via email, from among one or more files stored in the file source corresponding to the selected option;
generating an email including the selected file; and
sending the email,
wherein the plurality of options comprises a first option corresponding to a storage medium inside of the image forming apparatus, and a second option corresponding to a storage medium outside of the image forming apparatus.

24. The method as claimed in claim 23, wherein the plurality of options further comprises a third option corresponding to an image file to be generated by scanning a document.

25. A method of sending email from an image forming apparatus, the method comprising:
receiving a user selection of an option, from a plurality of options, of a file source;
receiving a user selection of a file that is to be transmitted via email, from among one or more files stored in the file source corresponding to the selected option;
generating an email including the selected file; and
sending the email,
wherein the plurality of options comprises a first option corresponding to a storage medium outside of the image forming apparatus, and a second option corresponding to an image file to be generated by scanning a document.
